(19) United States
(12) Patent Application Publication
(10) Pub. No.: US 2026/0310356 A1
(43) Pub. Date: Oct. 8, 2026

(54) OPTIMIZED STORAGE DEVICE SIZING THROUGH CUSTOMER WORKLOAD ANALYSIS

(71) Applicant: Dell Products L.P., Round Rock, TX (US)

(72) Inventors: Earl Medeiros, Fall River, MA (US); Malak Alshawabkeh, Franklin, MA (US); Ramesh Doddaiah, Westborough, MA (US)

(73) Assignee: Dell Products L.P., Round Rock, TX (US)

(21) Appl. No.: 19/170,480

(22) Filed: Apr. 4, 2025

(51) Int. Cl. G06F 3/06

(52) U.S. Cl. CPC G06F 3/0616; G06F 3/0634; G06F 3/0679

(57) ABSTRACT

A method, comprising: retrieving telemetry data that is reported by onboard controllers of one or more first storage devices in a first storage system; detecting whether the telemetry data satisfies a condition that evaluates whether the one or more first storage devices are subjected to wear that would cause a predetermined storage device type to fail before an end of a given period; generating, based on whether the condition is satisfied, a recommendation regarding a usage of the predetermined storage device type in a storage system configuration, wherein, when the condition is not satisfied, the recommendation provides that the predetermined storage device type is prohibited from being used in the storage system configuration, and when the condition is satisfied, the recommendation provides that the predetermined storage device type is allowed to be used in the storage system configuration, and generating the storage system configuration based on the recommendation.

### BACKGROUND

A distributed storage system may include a plurality of storage devices (e.g., storage arrays) to provide data storage to a plurality of nodes. The plurality of storage devices and the plurality of nodes may be situated in the same physical location, or in one or more physically remote locations. The plurality of nodes may be coupled to the storage devices by a high-speed interconnect, such as a switch fabric.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

According to aspects of the disclosure, a method is provided, comprising: retrieving telemetry data that is reported by onboard controllers of one or more first storage devices in a first storage system, the telemetry data being indicative of a frequency at which memory cells in the first storage devices are programmed and erased; detecting whether the telemetry data satisfies a condition that evaluates whether the one or more first storage devices are subjected to wear that would cause a predetermined storage device type to fail before an end of a given period; generating, based on whether the condition is satisfied, a recommendation regarding a usage of the predetermined storage device type in a storage system configuration, wherein, when the condition is not satisfied, the recommendation provides that the predetermined storage device type is prohibited from being used in the storage system configuration, and when the condition is satisfied, the recommendation provides that the predetermined storage device type is allowed to be used in the storage system configuration, and generating the storage system configuration based on the recommendation, wherein the storage system configuration identifies second storage devices to be included in a second storage system that is being defined, such that the second storage devices belong to the predetermined storage device type if and only if the recommendation indicates that the predetermined storage device type is allowed to be used in the storage system configuration.

According to aspects of the disclosure, a system is provided, comprising: a memory; and at least one processor that is operatively coupled to the memory, the at least one processor being configured to perform the operations of: retrieving telemetry data that is reported by onboard controllers of one or more first storage devices in a first storage system, the telemetry data being indicative of a frequency at which memory cells in the first storage devices are programmed and erased; detecting whether the telemetry data satisfies a condition that evaluates whether the one or more first storage devices are subjected to wear that would cause a predetermined storage device type to fail before an end of a given period; generating, based on whether the condition is satisfied, a recommendation regarding a usage of the predetermined storage device type in a storage system configuration, wherein, when the condition is not satisfied, the recommendation provides that the predetermined storage device type is prohibited from being used in the storage system configuration, and when the condition is satisfied, the recommendation provides that the predetermined storage device type is allowed to be used in the storage system configuration, and generating the storage system configuration based on the recommendation, wherein the storage system configuration identifies second storage devices to be included in a second storage system that is being defined, such that the second storage devices belong to the predetermined storage device type if and only if the recommendation indicates that the predetermined storage device type is allowed to be used in the storage system configuration.

According to aspects of the disclosure, a non-transitory computer readable medium is provided storing one or more processor-executable instructions, which when executed by at least one processor, cause the at least one processor to perform the operations of: retrieving telemetry data that is reported by onboard controllers of one or more first storage devices in a first storage system, the telemetry data being indicative of a frequency at which memory cells in the first storage devices are programmed and erased; detecting whether the telemetry data satisfies a condition that evaluates whether the one or more first storage devices are subjected to wear that would cause a predetermined storage device type to fail before an end of a given period; generating, based on whether the condition is satisfied, a recommendation regarding a usage of the predetermined storage device type in a storage system configuration, wherein, when the condition is not satisfied, the recommendation provides that the predetermined storage device type is prohibited from being used in the storage system configuration, and when the condition is satisfied, the recommendation provides that the predetermined storage device type is allowed to be used in the storage system configuration, and generating the storage system configuration based on the recommendation, wherein the storage system configuration identifies second storage devices to be included in a second storage system that is being defined, such that the second storage devices belong to the predetermined storage device type if and only if the recommendation indicates that the predetermined storage device type is allowed to be used in the storage system configuration.

### BRIEF DESCRIPTION OF THE DRAWING FIGURES

Other aspects, features, and advantages of the claimed invention will become more fully apparent from the following detailed description, the appended claims, and the accompanying drawings in which like reference numerals identify similar or identical elements. Reference numerals that are introduced in the specification in association with a drawing figure may be repeated in one or more subsequent figures without additional description in the specification in order to provide context for other features.

FIG. 1 is a diagram of an example of a system, according to aspects of the disclosure;

FIG. 2 is a diagram of an example of a sizer application, according to aspects of the disclosure;

FIG. 3 is a flowchart of an example of a process, according to aspects of the disclosure;

FIG. 4 is a flowchart of an example of a process, according to aspects of the disclosure; and

FIG. 5 is a flowchart of an example of a computing device, according to aspects of the disclosure.

### DETAILED DESCRIPTION

There are many different types of non-volatile solid-state storage devices. These types include Single Level Cell (SLC) storage devices, Multi-level cell (MLC) flash storage devices, Tripple-level cell (TLC) flash storage devices, Quad-Level Cells (QLCs) or Penta-level cell (PLC) devices. SLC, MLC, TLC, QLC, and PLC differ in the amount of data they can store per memory cell. SLC devices can store one bit of data in each memory cell. MLC devices can store two bits in each of their memory cells. TLC devices can store three bits in each of their memory cells. QLC devices can store four bits in each of their memory cells. PLC devices can store five bits in each of their memory cells. In other words, QLC and PLC storage devices have the largest storage density and the lowest production cost per gigabyte, which makes the use of PLC and QLC storage devices highly desirable in storage systems.

One disadvantage that QLC and PLC storage devices have over SLC, MLC, and TLC storage devices is that they are less durable. For example, an SLC storage device may endure tens of thousands to hundreds of thousands of program-erase (P/E) cycles. An MLC device may have an endurance in the range of tens of thousands P/E cycles. A TLC device may have an endurance in the range of a few thousand to tens of thousands P/E cycles. And a QLC device may have endurance in the range of hundreds to a couple of thousand P/E cycles, while a PLC device may have an even lower endurance.

This disadvantage is significant. If QLC (Quad-Level Cell) or PLC (Penta-Level Cell) storage devices are included in a storage system that experiences workloads unsuitable for low-endurance storage, it can result in poor performance and overutilization of hardware. This, in turn, leads to higher customer costs, decreased sustainability metrics, and undesirable performance characteristics. On the other hand, not using QLC and PLC devices can increase the overall cost of the storage system. In other words, there is a strong incentive to use high-density storage devices (such as QLC and PLC) because they have a lower cost, but using such devices carries the risk of premature device failure.

An example is now provided of the sales process for a storage system. In general, when a customer wishes to purchase a storage system, the customer will interact with a sales team that includes one or more sales representatives. The process that the sales team follows may include the following stages: (i) a customer evaluation stage, (ii) a model-based recommendation stage, and (iii) a final recommendation stage. During the customer evaluation stage, the sales team may meet with the customer and obtain information about the customer's needs and the workload the customer is expected to place on the system. During the model-based recommendation stage, the sales team may input the collected information into a sizer tool, and the sizer tool may output a system configuration (either full or partial). During the final recommendation stage, the sales team may evaluate and/or modify the system configuration and determine whether to offer it for sale to the customer.

Sizer tools are well-known in the industry. One example is the PowerStore Sizer™, developed by Dell Inc. in Round Rock, Texas. Generally, sizer tools take customer input and produce a system configuration as output, which may be either full or partial. The customer input can include various details relevant to selecting a storage system. This information might encompass budget, the amount of storage space needed, the type of data intended for storage, the expected workload on the system (measured in IOPS or MiB/s), the potential for growth beyond the current requirements, and the desired read/write mix of the workload. Specifics may include the percentage of random reads, the required bandwidth, the percentage of sequential reads and writes, expected data reduction ratios, and any other pertinent factors. The resulting system configuration may identify the model name or number of the recommended storage system, the number of CPUs it contains, the number of cores per CPU, the types of I/O modules (such as Fiber or RJ45), the RAID array configuration (for instance, RAID 4+1 or RAID 7+2), the size of the RAID array, the type and amount of random access memory (RAM) included in the system, and any other relevant information.

Conventional sizer tools do not account for drive wear. Rather, they may focus on generic system performance such as max IOPS or bandwidth. Specifically, conventional sizer tools do not account for drive QLC NAND technology limitations that impact the duration, nor do they consider factors such as the drives' write performance (garbage collection), endurance (wear level), and efficiency (WAF).

Conventional sizing tools do not adequately account for considerations that would allow them to assess whether QLC storage devices (or other types of high-density storage devices) are appropriate for a specific customer. Additionally, they do not evaluate whether such QLC storage devices should be included in the system configuration being offered for sale. While there is a strong incentive to recommend QLC storage devices due to their lower cost, an incorrect recommendation can lead to significant issues, including premature system wear, reduced system availability, and increased maintenance costs. Therefore, there is a need for solutions that can determine the suitability of QLC storage devices (or other high-density storage devices) for a particular application.

The present disclosure addresses this need. It provides a system and method for determining the suitability of QLC storage devices—or other types of high-density or low-density storage devices—for specific customers. This system or method can be integrated into a sizing tool, and the determinations made can help generate a tailored system configuration for each customer. If the system concludes that QLC storage devices are suitable for a particular customer, the generated system configuration will include these devices. Conversely, if the system determines that QLC storage devices are not appropriate for the customer, the resulting configuration will exclude them and suggest alternative storage solutions instead. The advantage of using this system or method lies in its ability to help users of sizing tools recommend QLC storage devices when it is beneficial, thereby reducing costs. At the same time, it prevents them from recommending QLC storage devices when such a choice could lead to issues in the long term.

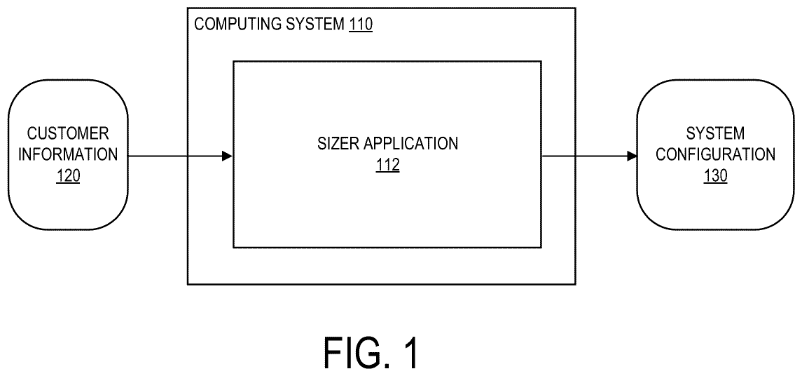

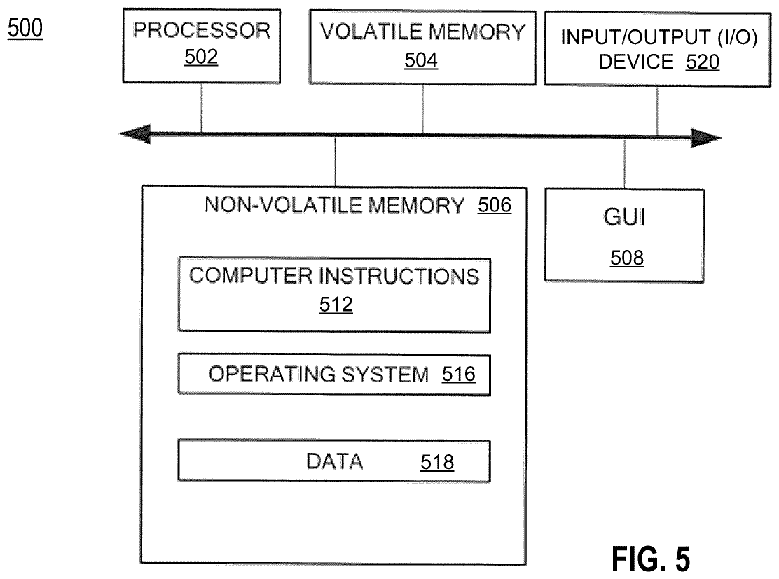

FIG. 1 is a diagram of an example of a computing system 110 that is configured to execute a sizer application 112. Computing system 110 may include one or more computing devices, such as the computing device 500, which is discussed further below with respect to FIG. 5. The sizer application 112 may be implemented as a web-based application, a standalone application, and/or any other suitable type of application. The sizer application 112 may receive customer information 120 as input. The sizer application 112 may generate a system configuration 130 based on the customer information 120. The sizer application 112 may output the system configuration 130 for presentation to a user. Outputting the system configuration 130 may include displaying the system configuration 130 on a display device, transmitting the system configuration 130 over a communications network, storing the system configuration 130 in a database or another predetermined memory location, and/or any other similar action.

The system configuration 130 may include various data that identifies one or more of the following: (i) the model of the storage system, (ii) the number of CPUs in the storage system, (iii) the amount of RAM in the storage system, and/or other relevant storage information. In this example, the system configuration specifies (i) the types of non-volatile storage devices to be included in the storage system (e.g., PLC or SLC storage devices), (ii) the number of these non-volatile storage devices, and (iii) the individual or total capacity of the non-volatile storage devices. In some implementations, the system configuration 130 may include a text file or another type of object that contains information enabling a vendor to either assemble the storage system (as identified by the system configuration 130) or retrieve it from a warehouse for delivery to the customer.

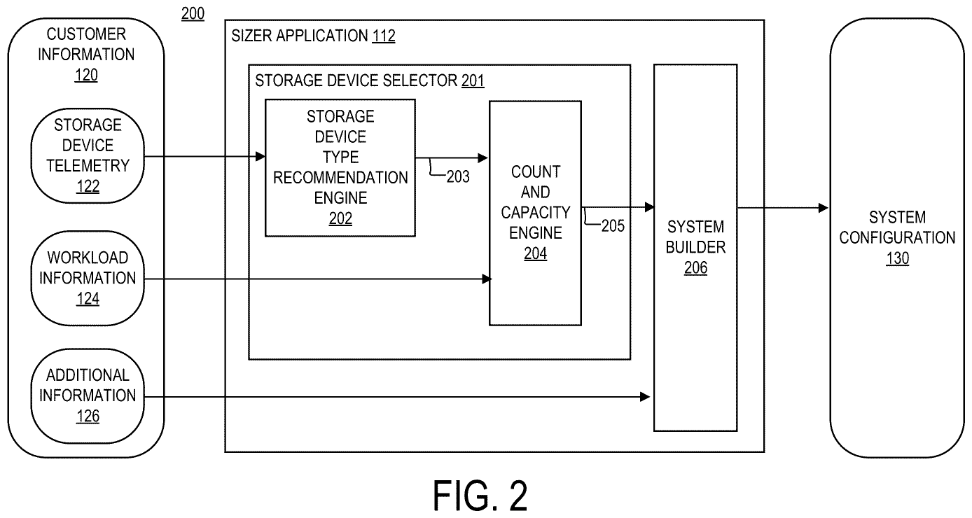

FIG. 2 is a diagram illustrating aspects of the operation of the sizer application 112 in further detail, according to one implementation.

In one aspect, FIG. 2 illustrates that the customer information 120 may include storage device telemetry 122 (hereinafter “telemetry data 122”), workload information 124, and additional information 126.

Telemetry data 122 may include data that is reported by the onboard controllers of the storage devices of a customer's current storage system. The onboard controller of a storage device may include a dedicated microcontroller or system-on-a-chip that is integrated directly into the hardware of the storage device. The controller may perform functions such as data management, error correction, wear leveling or garbage collection. In some implementations, the telemetry data 122 may include Self-Monitoring, Analysis, and Reporting Technology data. Telemetry (S.M.A.R.T.) data 122 may include one or more data items. In some implementations, at least some of the data items may be reported by different storage devices that are part of the customer's current storage system. Alternatively, in some implementations, all data items may be reported by the same storage device.

Telemetry data 122 may be collected during the customer evaluation stage of a process that involves making an offer to the customer to purchase an upgrade to the customer's existing storage system (hereinafter “the customer's current storage system”). According to the present example, any of the data items that are part of telemetry data 122 may include write amplification factor (WAF) data, drive writes per day (DWPD data), host writes per day data, I/O performance metrics that are specific to a particular storage device (as opposed to the storage system or RAID array of which the device is part), and RAID configuration data. However, the present disclosure is not limited to any specific type of data being included in telemetry data 122. In some implementations, telemetry data 122 may include data that is indicative of the rate at which P/E cycles are completed by storage devices in the customer's current storage system.

As is well known in the art, a WAF (Write Amplification Factor) data item indicates the ratio of internal drive writes to host writes. A DWPD (Drive Writes Per Day) data item specifies the number of full-drive writes that can safely occur each day without exceeding the endurance rating of the storage device. Typically, a DWPD of 0.26 is recommended for the safe operation of QLC (Quad-Level Cell) drives. The host writes per day for a specific storage device measure the total amount of data written to that device within a twenty-four hour period. In contrast, the drive writes per day (NAND writes) refer to the actual number of writes occurring internally in the NAND flash cells of the storage device. The IO performance metrics for a particular storage device can include various data points, such as IPOS (Input/Output Operations Per Second) specific to that device (as opposed to the IOPS for the RAID array or storage system to which the device belongs), latency, throughput, and more. These types of telemetry data are provided as examples only. In some cases, the telemetry data may be gathered over a predetermined time frame, such as the past two months. In such implementations, this data may encompass the respective WAF (or another telemetry item) for each day during that period for each storage device in the storage system. It should be noted that the present disclosure is not limited to any specific type or amount of telemetry data being collected.

As noted above, telemetry data 122 may be indicative of the frequency at which the memory cells (e.g., NAND memory cells) in the customer's current storage system are programmed and erased. In this regard, telemetry data may also be regarded as including write metrics of one or more storage devices that are part of the customer's storage system.

In some implementations, telemetry data 122 may be time series data. The time series data may include one or more data frames, wherein each data frame corresponds to a different time instant (or a different time period, time point, etc.). Each data frame may include one or more of the telemetry data types discussed above. For example, a frame may include a plurality of WAF values where each WAF value is reported by a different one of the plurality of storage devices in the customer's current storage system. In another example, each data frame may include (or consist of) a single WAF value that is reported by a given storage device, or the frame may include WAF values that are reported by different storage devices. Furthermore, in some implementations, in addition to (or instead of) WAF values, each frame may include DWPD values, host write per day values, IO performance metric values, etc. The data items in each frame may be reported by the same storage device or by different storage devices.

The workload information 124 may include any suitable type of information that is customarily provided to sizer tools to determine the storage capacity of the storage system. The term “capacity,” as used in this context, refers to the size of the storage system or the amount of data that the storage system can store. In this regard, the workload information may identify one or more of the desired IOPS for the storage system, the desired throughput of the storage system, an indication of how the needs of the customer are expected to change in the next few years, and so forth. The present disclosure is not limited to any specific type of information being included in the workload information 124.

The additional information 126 may include any suitable type of information that is customarily provided to sizer tools to determine system configuration. The present disclosure is not limited to any specific type of information being included in the additional information 126.

In another aspect, FIG. 2 illustrates that sizer application 112 may include a storage device selector 201 (hereinafter “selector 201”) and a system builder 206 (hereinafter “builder 206”). Selector 201 may be implemented in software, in hardware, or as a combination of hardware and software. Builder 206 may be implemented in software, in hardware, or as a combination of hardware and software. In one example, selector 201 may provide builder 206 with a recommendation 205 of the type, number, and capacity of storage devices that are going to be included in the system configuration 130. In response to receiving the indication, builder 206 may generate a system configuration 130 in such a way that it includes the specified type, number, and capacity of storage devices. The rest of system configuration 130 may be generated in the same manner as conventional sizer tools perform this task.

In one example, the selector 201 may include a storage device type recommendation engine 202 (hereinafter “engine 202”) and a count and capacity engine 204 (hereinafter “engine 204”). Engine 202 may be configured to generate a recommendation 203 and provide recommendation 203 to engine 204. Recommendation 203 may include any suitable number, string, or alphanumerical string that, at least in part, indicates whether a predetermined type of storage device is permitted to be included in the system configuration 130. According to the present example, the predetermined type of storage device is QLC, and recommendation 203 indicates whether any QLC storage devices are allowed to be made part of system configuration 130. However, in alternative implementations, the predetermined type of storage device may be different.

In one example, the recommendation 203 may be a binary number. When the binary number is ‘0’, this means that QLC devices are not permitted to be included in system configuration 130. When the binary number is ‘1’, this means that QLC devices are allowed to be included in system configuration 130.

Engine 202 and builder 206 may be arranged to abide by recommendation 203 when recommendation 203 is negative. In other words, when the binary number is set to ‘0’, recommendation 205 is guaranteed not to include a suggestion to include QLC devices, and system configuration 130 is guaranteed not to include any QLC devices. In other words, when the binary number is set to ‘0’, recommendation 205 may recommend the use of another type of storage device (e.g., SLC device), and system configuration 130 may include the other type of storage device.

On the other hand, when recommendation 205 is positive, engine 202 and builder 206 may or may not be strictly bound by recommendation 205. In other words, when the binary number is ‘1’, recommendation 205 may or may not suggest the inclusion of QLC devices in system configuration 130. If engine 202 determines that QLC devices are permitted to be included in system configuration 130, this may be overridden by other logic that is part of engine 204. In this case, recommendation 205 may end up dictating the use of a different type of storage device. Of course, in some implementations, engine 204 may be configured to recommend the use of QLC devices every time recommendation 203 permits the use of such devices. The present disclosure is not limited to any specific method for generating recommendation 205 based on recommendation 203, for as long as recommendation 205 cannot suggest the use of QLC devices when recommendation 203 provides that such devices are not permitted to be included in system configuration 130.

Engine 204 may generate recommendation 205 based at least in part on recommendation 203. Recommendation 205 may include any suitable type of number, string, or alphanumerical string. In some implementations, recommendation 205 may specify one or more of: (i) the type of storage devices that are going to be used in system configuration 130, (ii) the individual size of each of the storage devices, and (iii) the combined size of the storage devices. In one example, recommendation 205 may provide “2PB of QLC capacity, 30 GB per drive”. In another example, the recommendation may 205 may provide “750 TB QLC capacity, 15 GB per drive”. The total amount of storage that the drives should provide may be determined in the same manner as conventional sizer applications perform this task. As used herein, the terms “drive” and storage” device are used interchangeably.

In one implementation, the type of storage device that is going to be included in system configuration 130 may be determined as follows: (i) if recommendation 203 indicates that QLC drives are permitted to be included in system configuration 130, recommendation 205 may be arranged to require the use of QLC storage devices; (ii) otherwise, if recommendation 203 indicates that QLC drives are not permitted to be used in system configuration 130, recommendation 205 may be configured to require the use of the next least expensive storage device type (or another storage device type), etc.

The operation of engine 202 is now described in further detail. In some implementations, engine 202 may be configured to execute an autoregressive integrated moving average (ARIMA) model based on the telemetry data 122. As noted above, the telemetry data 122 may be a time series data set. The data set may identify the value of a metric at different time instants in the past. Engine 202 may use the ARIMA model to predict the value of the metric in a future time instant. The future time instant may be one day from the current time instant, one month from the current time instant, one year from the current time instant, and/or any other future time instant. Next, engine 202 may determine if the future value of the metric satisfies a predetermined condition. For example, engine 202 may compare the future value against a threshold and determine whether the condition is satisfied based on the outcome of the comparison. When the condition is satisfied, engine 202 may set recommendation 203 to a value that indicates that QLC drives are permitted to be used in system configuration 130. When the condition is not satisfied, engine 202 may set recommendation 203 to a value that indicates that QLC drives are not permitted to be used in system configuration 130.

The condition that is evaluated is now described in further detail. In general, the condition may evaluate whether the metric indicates that the storage device(s) from which the metric is obtained is/are not subjected to an amount of wear that would cause a QLC device (or another predetermined type of drive) to fail prematurely and/or before the end of a given period (e.g., 5 years, etc.). The condition may be satisfied when the future value indicates less than the amount of wear that would cause a QLC drive to fail prematurely or before the end of the given period. The condition may not be satisfied when the future value indicates an amount of wear that would cause a QLC device to fail prematurely or before the end of the given satisfied. Depending on the type of metric that is being used, in one implementation, the condition may be satisfied when the future value of the metric is greater than or equal to the threshold and not satisfied when the future value of the metric is less than the threshold. In an alternative implementation, the condition may be satisfied when the future value of the metric is less than or equal to the threshold and not satisfied when the future value of the metric is greater than the threshold. The present disclosure is not limited to any specific condition being used.

A brief discussion is now provided of the time series dataset that is used to evaluate the ARIMA model. Telemetry data 122 may be a time series data set formatted in the manner discussed above. Consider an example in which each frame I in the dataset corresponds to a different time instant and includes a set S_{I} of telemetry data values. The set S_{I} may include one or more telemetry data values. In instances in which the set S_{I} includes multiple telemetry data values all telemetry data values may be reported by the same storage device. Alternatively, in instances in which the set S_{I} includes multiple telemetry data values, at least two telemetry data values may be reported by different storage devices. In some implementations, the set S_{I} may include telemetry data values of the same type—e.g., the set may include only WAF values. Alternatively, in some implementations, the set S_{I} may include multiple types of telemetry data values, e.g., the set may include WAF values, DWPD values, host writes per day values, etc.

A discussion is now provided of the metric whose value is predicted with the ARIMA model. In some implementations, the metric may be a singular metric. Alternatively, in some implementations, the metric may be a composite metric.

An example is now provided of a singular metric. A singular metric may be the WAF value (or another type of telemetry data value) that is reported by a given storage device in the plurality of storage devices that are part of the customer's current storage system. In such implementations, the future metric that is predicted with the ARIMA model may be the WAF value (or another type of telemetry data value) that is going to be reported at the future time instant (e.g., by the same storage device). The singular metric may be an indication of the wear that is experienced by the given storage device. Additionally or alternatively, the singular metric may indicate the frequency at which memory cells in the given storage device (e.g., NAND memory cells) are programmed and erased.

An example is now provided of another singular metric. Consider an example of an arrangement in which each frame in the time series includes a plurality of WAF values, wherein each WAF value is reported by a different storage device in the customer's current storage system. In such implementations, a singular metric may be the largest WAF value in the plurality. In this regard, the predicted metric may be the largest WAF value that would be reported by any of the storage devices in at a given future time instant. The singular metric may be an indication of the wear that is experienced, as a group, by the storage devices that provided the plurality of WAF values (or other telemetry values) from which the singular metric was picked. Additionally or alternatively, the singular metric may indicate the frequency at which memory cells in the given storage devices are programmed and erased.

An example of a composite metric is now provided. Composite metrics are those metrics that are generated by combining one or more different singular metrics. The singular metrics may be of the same type or from different types. Combining the singular metrics may include evaluating a mathematical expression that takes the metrics as arguments. Consider an example of an arrangement in which each frame in the time series includes different types of telemetry data, such as WAF values, DWPD values, host writes per day values, etc. In such implementations, the composite metric may be generated by combining the values in the frame. For example, the composite metric may be the sum of the values or their weighted average, etc. In this example, the predicted metric may be the value that would result when the telemetry data values reported by the storage devices at the future time instant are combined in the same manner. The composite metric may be an indication of the wear that is experienced by the storage device(s) that provided that data used to calculate the composite metric. Additionally or alternatively, the singular metric may indicate the frequency at which memory cells in the given storage devices are programmed and erased.

In some implementations, the ARIMA model may be fitted by using time series telemetry training data from other storage system. This training data may have the same format as telementry data 122. In some implementations, the ARIMA model may be trained by performing the steps which are listed in Table 1 below:

TABLE 1
Step 1: Visualize the Training Data that is Organized in a Time Series
Step 2: Make the Time Series Stationary
Step 3: Choose ARIMA Model Parameters
Step 4: Train the ARIMA Model
Step 5: Evaluate the Model
Step 6: Tune the Model
Step 7: Forecast with the Model
Step 8: Validate the Forecast

In some implementations, Steps 1-4 may be performed by executing the Python code which is provided in Table 2 below, which uses standard libraries that are provided with Python:

TABLE 2

from statsmodels.tsa.arima.model import ARIMA
# Define the model with chosen p, d, q
model = ARIMA(data, order=(p, d, q))
# Fit the model to the data
model_fit = model.fit( )

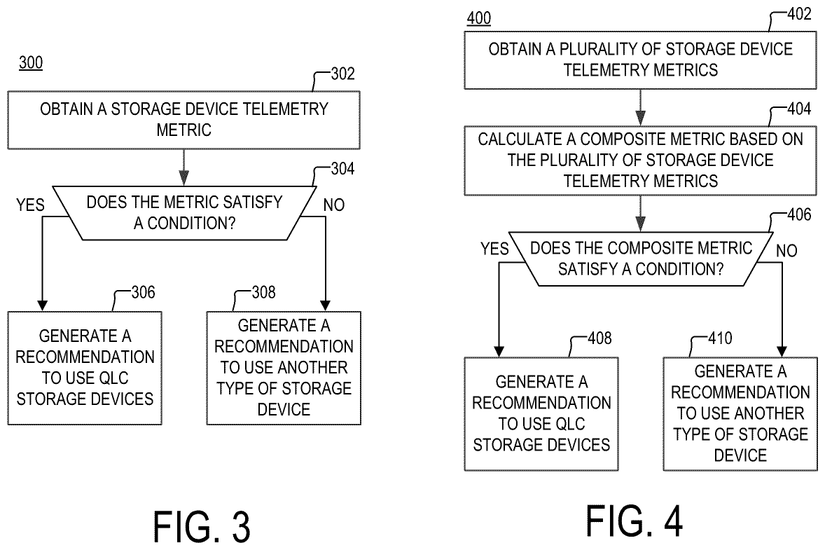

An alternative example of the operation of engine 202 is now provided in further detail. In some implementations, engine 202 may be implemented as a rule-based engine that evaluates rules based on telemetry data. The outcome of the evaluation may be an indication of whether QLC devices are permitted to be included in system configuration 130. When engine 202 is implemented as a rule-based engine, engine 202 may be configured to execute one or more of processes 300 and 400, which are discussed further below with respect to FIGS. 3 and 4, respectively.

FIG. 3 is a flowchart of an example of a process 300, according to aspects of the disclosure.

At step 302, engine 202 obtains a storage device telemetry metric. The telemetry metric may be a telemetry data item that is reported by any of the storage devices in the customer's current storage system (hereinafter “source storage device”). For example, the obtained metric may include one of the most recent WAF values that are reported by the storage device, the most recent host writes per day value that is reported by the storage device, the most recent drive writes per day value that is reported by the storage device, etc. In another example, the obtained metric may be the largest WAF value in a plurality of WAF values, wherein each WAF value in the plurality is the most recent WAF value that is reported by a different one of the storage devices in the customer's current storage system. In another example, the obtained metric may be the largest drive writes per day value in a plurality of drive writes per day values, wherein each drive writes per day value in the plurality is the most recent drive writes per day value that is reported by a different one of the storage devices in the customer's storage system. In some implementations, the telemetry metric may be one of the values that constitute telemetry data 122. When telemetry data is implemented as a time series, the telemetry metric may be retrieved from the most recent (or another) frame in the time series.

At step 304, engine 202 determines if the storage device telemetry metric (obtained at step 302) satisfies a condition. According to the present example, engine 202 compares the metric against a threshold and determines if the condition is satisfied based on the outcome of the comparison. According to the present example, the condition is satisfied if the metric is greater than or equal to the threshold and not satisfied when the metric is less than the threshold. However, in alternative implementations, the condition may be satisfied when the metric is less than or equal to the threshold and not satisfied when the metric is greater than the threshold.

The condition may evaluate whether the metric indicates that the source storage device is subjected to an amount of wear that would cause a QLC device (or another predetermined type of drive) to fail prematurely and/or before the end of a given period (e.g., 5 years, etc.). In general, the condition may be satisfied when the metric indicates that the source storage device is not subjected to an amount of wear that would cause a QLC device to fail prematurely and/or before the end of a given period (e.g., 5 years, etc.). On the other hand, the condition may not be satisfied when the metric indicates that the source storage device is subjected to an amount of wear that would cause a QLC device to fail prematurely and/or before the end of a given period (e.g., 5 years, etc.). In this regard, the metric may provide a measure of the wear experienced by the storage device and/or the frequency at which the memory cells in the storage device are programmed and erased. If the condition is satisfied, process 300 proceeds to step 306. Otherwise, if the condition is not satisfied, process 300 proceeds to step 308.

Consider an example in which the metric (obtained at step 302) is a WAF value returned by one of the storage devices in the customer's storage system. It is well known that WAF is directly proportional to wear, whereby the greater the WAF value, the greater the wear that is imparted on the storage device. In this example, the condition may be satisfied if the WAF value is below a predetermined threshold. On the other hand, if the metric were inversely proportional to the amount of wear, the condition would be satisfied when the metric stays above a threshold.

At step 306, engine 202 sets recommendation 203 to a value that indicates that QLC devices are permitted to be included in system configuration 130. As noted above, setting recommendation 203 to such a value would allow engine 204 to use QLC storage devices in system configuration 130.

At step 308, engine 202 sets recommendation 203 to a value that indicates that QLC devices are not permitted to be included in system configuration 130. As noted above, setting recommendation 203 to such a value would force engine 204 to select another type of storage device for inclusion in system configuration 130.

FIG. 4 is a flowchart of an example of a process 400, according to aspects of the disclosure.

At step 402, engine 202 obtains a plurality of storage device telemetry metrics. Each of the storage device telemetry metrics may be a telemetry data value that is reported by one of the storage devices in the customer's current storage system (hereinafter “source storage devices”). In some implementations, the telemetry metrics may include some or all of the values that constitute the telemetry data set 122. When the telemetry data is implemented as a time series, the telemetry metrics may be retrieved from one or more frames that are part of the time series. For example, the telemetry metrics may be retrieved form a single frame (e.g., the most recent frame). In another example, the telemetry metrics may be retrieved from multiple frames in the time series which correspond to different time instants.

At step 404, engine 202 calculates a composite metric based on the plurality of storage device telemetry metrics. The composite metric may be generated by combining the plurality of storage device telemetry metrics. According to the present example, the composite metric is the weighted average of the telemetry metrics. However, the present disclosure is not limited thereto.

At step 406, engine 202 determines if the composite metric satisfies a condition. According to the present example, engine 202 compares the composite metric against a threshold and determines if the condition is satisfied based on the outcome of the comparison. According to the present example, the condition is satisfied if the composite metric is greater than or equal to the threshold and not satisfied when the metric is less than the threshold. However, in alternative implementations, the condition may be satisfied when the metric is less than or equal to the threshold and not satisfied when the metric is greater than the threshold.

In general, the condition may evaluate whether the metric indicates that the source storage devices are subjected to an amount of wear that would cause a QLC device (or another predetermined type of drive) to fail prematurely and/or before the end of a given period (e.g., 5 years, etc.). In general, the condition may be satisfied when the metric indicates that the source storage devices are not subjected to the amount of wear that would cause a QLC device to fail prematurely and/or before the end of a given period (e.g., 5 years, etc.). On the other hand, the condition may not be satisfied when the metric indicates that the source storage devices are subjected to an amount of wear that would cause a QLC device to fail prematurely and/or before the end of a given period (e.g., 5 years, etc.). In this regard, the composite metric may be a measure of the wear that is experienced, as a group, by the storage devices that provided the telemetry data for generating the metric and/or the frequency at which the memory cells in the storage devices are programmed and erased. If the condition is satisfied, process 400 proceeds to step 408. Otherwise, if the condition is not satisfied, process 400 proceeds to step 410.

Consider an example in which the composite metric (obtained at step 406) is the average of WAF values that are reported by a plurality of storage devices in the customer's storage system. It is well known that WAF is directly proportional to wear, whereby the greater the WAF value, the greater the wear that is imparted on the storage device. In this example, the condition may be satisfied if the average WAF value is below a predetermined threshold. On the other hand, if the composite metric were inversely proportional to the amount of wear, the condition would be satisfied when the metric stays above a threshold.

At step 408, engine 202 sets recommendation 203 to a value that indicates that QLC devices are permitted to be included in system configuration 130. As noted above, setting recommendation 203 to such a value would allow engine 204 to use QLC storage devices in system configuration 130.

At step 410, engine 202 sets recommendation 203 to a value that indicates that QLC devices are not permitted to be included in system configuration 130. As noted above, setting recommendation 203 to such a value would force engine 204 to select another type of storage device for use inclusion in system configuration 130.

Referring to FIG. 5, in some embodiments, a device 500 may include processor 502, volatile memory 504 (e.g., RAM), non-volatile memory 506 (e.g., a hard disk drive, a solid-state drive such as a flash drive, a hybrid magnetic and solid-state drive, etc.), graphical user interface (GUI) 508 (e.g., a touchscreen, a display, and so forth) and input/output (I/O) device 520 (e.g., a mouse, a keyboard, etc.). Non-volatile memory 506 stores computer instructions 512, an operating system 516 and data 518 such that, for example, the computer instructions 512 are executed by the processor 502 out of volatile memory 504. Program code may be applied to data entered using an input device of GUI 508 or received from I/O device 520.

FIGS. 1-5 are provided as an example only. In some embodiments, the term “I/O request” or simply “I/O” may be used to refer to an input or output request. In some embodiments, an I/O request may refer to a data read or write request. At least some of the steps discussed with respect to FIGS. 1-5 may be performed in parallel, in a different order, or altogether omitted. As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

To the extent directional terms are used in the specification and claims (e.g., upper, lower, parallel, perpendicular, etc.), these terms are merely intended to assist in describing and claiming the invention and are not intended to limit the claims in any way. Such terms do not require exactness (e.g., exact perpendicularity or exact parallelism, etc.), but instead it is intended that normal tolerances and ranges apply. Similarly, unless explicitly stated otherwise, each numerical value and range should be interpreted as being approximate as if the word “about”, “substantially” or “approximately” preceded the value of the value or range.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

While the exemplary embodiments have been described with respect to processes of circuits, including possible implementation as a single integrated circuit, a multi-chip module, a single card, or a multi-card circuit pack, the described embodiments are not so limited. As would be apparent to one skilled in the art, various functions of circuit elements may also be implemented as processing blocks in a software program. Such software may be employed in, for example, a digital signal processor, micro-controller, or general-purpose computer.

Some embodiments might be implemented in the form of methods and apparatuses for practicing those methods. Described embodiments might also be implemented in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the claimed invention. Described embodiments might also be implemented in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the claimed invention. When implemented on a general-purpose processor, the program code segments combine with the processor to provide a unique device that operates analogously to specific logic circuits. Described embodiments might also be implemented in the form of a bitstream or other sequence of signal values electrically or optically transmitted through a medium, stored magnetic-field variations in a magnetic recording medium, etc., generated using a method and/or an apparatus of the claimed invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

It will be further understood that various changes in the details, materials, and arrangements of the parts which have been described and illustrated in order to explain the nature of the claimed invention might be made by those skilled in the art without departing from the scope of the following claims.

1. A method, comprising:
retrieving telemetry data that is reported by a plurality of onboard controllers, each onboard controller being part of a different one of a plurality of first SSDs, each onboard controller being configured to perform wear leveling or garbage collection of the first SSD of which the onboard controller is part;
detecting whether the telemetry data satisfies a condition that evaluates whether the plurality of first SSDs are subjected to wear that would cause a predetermined SSD type to fail before an end of a given period;
generating, based on whether the condition is satisfied, a recommendation regarding a usage of the predetermined SSD type in a storage system configuration, wherein, when the condition is satisfied, the recommendation provides that the predetermined SSD type is prohibited from being used in the storage system configuration, and when the condition is not satisfied, the recommendation provides that the predetermined SSD type is allowed to be used in the storage system configuration, and
generating the storage system configuration based on the recommendation, wherein the storage system configuration identifies second SSDs to be included in a second storage system that is being defined, such that the second SSDs belong to the predetermined SSD type if and only if the recommendation indicates that the predetermined SSD type is allowed to be used in the storage system configuration,
wherein the telemetry data includes a plurality of frames, each of the plurality of frames includes at least two different types of telemetry data, each of the plurality of frames includes telemetry data that is reported by at least two different first SSDs, and detecting whether the condition is satisfied includes evaluating a machine learning model based on the plurality of frames to calculate a composite metric and comparing the composite metric to a threshold.

2. (canceled)

3. The method of claim 1, wherein the telemetry data is indicative of a frequency at which memory cells in the first SSDs are programmed and erased including as a result of performing internal writes.

4. The method of claim 1, wherein each of the plurality of frames includes a drive writes per day (DWPD) value.

5. The method of claim 1, wherein the machine learning model includes an Auto Regression Integrated Moving Average (ARIMA) model.

6. The method of claim 1, wherein the predetermined SSD type includes a quad-level cell (QLC) NAND device.

7. The method of claim 1, wherein each of the plurality of frames includes a write amplification factor (WAF) value.

8. A system, comprising:
a memory; and
at least one processor that is operatively coupled to the memory, the at least one processor being configured to perform the operations of:
retrieving telemetry data that is reported by a plurality of onboard controllers, each onboard controller being part of a different one of a plurality of first SSDs, each onboard controller being configured to perform wear leveling or garbage collection of the first SSD of which the onboard controller is part;
detecting whether the telemetry data satisfies a condition that evaluates whether the plurality of first SSDs are subjected to wear that would cause a predetermined SSD type to fail before an end of a given period;
generating, based on whether the condition is satisfied, a recommendation regarding a usage of the predetermined SSD type in a storage system configuration, wherein, when the condition is satisfied, the recommendation provides that the predetermined SSD type is prohibited from being used in the storage system configuration, and when the condition is not satisfied, the recommendation provides that the predetermined SSD type is allowed to be used in the storage system configuration, and
generating the storage system configuration based on the recommendation, wherein the storage system configuration identifies second SSDs to be included in a second storage system that is being defined, such that the second SSDs belong to the predetermined SSD type if and only if the recommendation indicates that the predetermined SSD type is allowed to be used in the storage system configuration,
wherein the telemetry data includes a plurality of frames, each of the plurality of frames includes at least two different types of telemetry data, each of the plurality of frames includes telemetry data that is reported by at least two different first SSDs, and detecting whether the condition is satisfied includes evaluating a machine learning model based on the plurality of frames to calculate a composite metric and comparing the composite metric to a threshold.

9. (canceled)

10. The system of claim 8, wherein the telemetry data is indicative of a frequency at which memory cells in the first SSDs are programmed and erased including as a result of performing internal writes.

11. The system of claim 8, wherein each of the plurality of frames includes a drive writes per day (DWPD) value.

12. The system of claim 8, wherein the machine learning model includes an Auto Regression Integrated Moving Average (ARIMA) model.

13. The system of claim 8, wherein the predetermined SSD type includes a quad-level cell (QLC) NAND device.

14. The system of claim 8, wherein each of the plurality of frames includes a write amplification factor (WAF) value.

15. A non-transitory computer readable medium storing one or more processor-executable instructions, which when executed by at least one processor, cause the at least one processor to perform the operations of:
retrieving telemetry data that is reported by a plurality of onboard controllers, each onboard controller being part of a different one of a plurality of first SSDs, each onboard controller being configured to perform wear leveling or garbage collection of the first SSD of which the onboard controller is part;
detecting whether the telemetry data satisfies a condition that evaluates whether the plurality of first SSDs are subjected to wear that would cause a predetermined SSD type to fail before an end of a given period;
generating, based on whether the condition is satisfied, a recommendation regarding a usage of the predetermined SSD type in a storage system configuration, wherein, when the condition is satisfied, the recommendation provides that the predetermined SSD type is prohibited from being used in the storage system configuration, and when the condition is not satisfied, the recommendation provides that the predetermined SSD type is allowed to be used in the storage system configuration, and
generating the storage system configuration based on the recommendation, wherein the storage system configuration identifies second SSDs to be included in a second storage system that is being defined, such that the second SSDs belong to the predetermined SSD type if and only if the recommendation indicates that the predetermined SSD type is allowed to be used in the storage system configuration,
wherein the telemetry data includes a plurality of frames, each of the plurality of frames includes at least two different types of telemetry data, each of the plurality of frames includes telemetry data that is reported by at least two different first SSDs, and detecting whether the condition is satisfied includes evaluating a machine learning model based on the plurality of frames to calculate a composite metric and comparing the composite metric to a threshold.

16. (canceled)

17. The non-transitory computer-readable medium of claim 15, wherein the telemetry data is indicative of a frequency at which memory cells in the first SSDs are programmed and erased including as a result of performing internal writes.

18. The non-transitory computer-readable medium of claim 15, wherein each of the plurality of frames includes a drive writes per day (DWPD) value.

19. The non-transitory computer-readable medium of claim 15, wherein the machine learning model includes an Auto Regression Integrated Moving Average (ARIMA) model.

20. The non-transitory computer-readable medium of claim 15, wherein the predetermined SSD type includes a quad-level cell (QLC) NAND device.
